(19) United States
(12) Patent Application Publication
(10) Pub. No.: US 2014/0274101 A1
(43) Pub. Date: Sep. 18, 2014

(54) METHODS AND SYSTEMS FOR LOAD BALANCING AND INTERFERENCE COORDINATION IN NETWORKS

(71) Applicant: Alcatel-Lucent USA Inc., Murray Hill, NJ (US)

(72) Inventor: Sivarama VENKATESAN, Milltown, NJ (US)

(73) Assignee: Alcatel-Lucent USA Inc., Murray Hill, NJ (US)

(21) Appl. No.: 13/803,620

(22) Filed: Mar. 14, 2013

(51) Int. Cl. H04W 72/04

(52) U.S. Cl. CPC H04W 72/0486
USPC 455/453

(57) ABSTRACT

At least one example embodiment discloses a method of balancing load and coordinating interference across a plurality of macro cells and small cells in a cellular network including the plurality of macro cells and small cells. The method includes determining serving cells of users, respectively, based on a Frank-Wolfe algorithm.

### BACKGROUND

Heterogeneous networks (HetNets or HTNs) are now being developed wherein cells of smaller size are embedded within the coverage area of larger macro cells and the small cells could even share the same carrier frequency with the umbrella macro cell, primarily to provide increased capacity in targeted areas of data traffic concentration. Such heterogeneous networks try to exploit the spatial distribution of users (and traffic) to efficiently increase the overall capacity of the wireless network. Those smaller-sized cells are typically referred to as pico cells or femto cells, and for purposes of the description herein will be collectively referred to as small cells. Such deployments present some specific interference scenarios for which enhanced inter-cell interference coordination (eICIC) techniques would prove beneficial.

In one scenario, the small cells are pico cells, which are open to users of the macro cellular network. In order to ensure that such pico cells carry a useful share of the total traffic load, user equipments (UEs) may be programmed to associate preferentially with the pico cells rather than the macro cells, for example by biasing the received signal power of the Common Reference Symbol (CRS), a quantity that may be referred to as reference signal received power (RSRP), such that UEs that are close to a pico cell will associate with the pico cell. Despite the association, UEs near the edge of a pico cell's coverage area will suffer strong interference from one or more macro cells. In order to alleviate such interference, some subframes may be configured as “almost blank” in the macro cell. An “almost blank” subframe is a subframe with reduced transmit power (e.g., reduced from a maximum transmit power) and/or a reduced activity subframe (e.g., contains only control information as compared to a fully loaded subframe). Legacy UEs (also called terminals) expect to find the reference signals for measurements but are unaware of the configuration of these special subframes. Almost blank subframes may contain synchronization signals, broadcast control information and/or paging signals.

In order to make use of almost blank subframes (ABSs) effective (note that hereafter the term “special” or “ABS” is used), signaling is provided from the macro cell to the pico cell across the corresponding backhaul interface, known in LTE as the “X2” interface. For LTE Release 10, it has been agreed that this X2 signaling will take the form of a coordination bitmap to indicate the ABS pattern (for example with each bit corresponding to one subframe in a series of subframes, with the value of the bit indicating whether the subframe is an ABS or not). Such signaling can help the pico cell to schedule data transmissions in the pico cell appropriately to avoid interference (e.g. by scheduling transmissions to UEs near the edge of the pico cell during ABSs), and to signal to the UEs the subframes which should have low macro cellular interference and should therefore be used for RRM/RLM/CQI measurements. (RRM=Radio Resource Management, typically relating to handover; RLM=Radio Link Monitoring, typically relating to detection of serving radio link failure; CQI=Channel Quality Information, derived from the signal strength from the serving cell and the interference from other cells, and typically used for link adaptation and scheduling on the serving radio link).

EICIC is an Interference Mitigation technique that involves the transmission of ABS from a macro cluster. During the transmission of ABS, only a subset of the broadcast channels is transmitted while PDSCH is muted. This allows underlaid small cells such as metro cells, femto cells and relays to transmit to the UEs that have selected those nodes with a better SINR.

Since LTE is a co-channel deployment (i.e., it has 1:1 frequency re-use in the different cells). The edge users' uplink performance can be severely impaired due to interference received from neighboring cells that use the same frequency due to 1:1 re-use. To mitigate the neighboring cell interference that limits the performance of edge users, the standards body has proposed the following approach: periodically, each cell sets cell-specific parameters that the associated UEs of the cell use to set their SINR target as a pre-defined function of these parameters and local path loss measurements. Precisely, the standards body has proposed a Fractional Power Control (FPC)-α scheme where a UE sets its transmits power (in dBm) according to the following relationship

Tx Power of UE=P₀(server cell)+α(server cell)*Path_Loss(between UE and server cell) (1)

where, parameters P₀ is the cell specific nominal transmit power and α is the cell-specific path loss compensation factor, both depending on the server cell of the UE. In equation (1) the transmitting power of the UE is understood to express transmitting power per Resource Block (RB).

### SUMMARY

Example embodiments disclose methods and systems for load balancing and interference coordination.

An issue that arises in HetNets is that of inter-cell load balancing, i.e., determining which cell (macro or pico) should serve each of a given set of users in the network, taking into account the spatial distribution of the users as well as differences in the capabilities of the cells themselves. In a macro cell-only network, each user equipment (UE) is generally served by a cell whose signal the UE receives at the highest signal-to-noise ratio (SNR).

However, in a HetNet, the highest-SNR association is likely to result in only a small fraction of UEs being served by the pico cells (due to the pico cells' lower power and antenna gain, and worse propagation characteristics). This underutilization of the pico cells leads to a gain in system capacity that is far from commensurate with the increase in cell density, since the available spectrum is reused only over a small fraction of the network area.

Since UEs would have to contend with fewer other users for use of the channel at such a macro cell, a UE may be served by a cell that does not produce the strongest SNR, but is lightly loaded.

UEs at the outer edges of an expanded service area of a pico cell are then exposed to severe interference from nearby macro cells. Without any further measures to mitigate such interference, it becomes impossible to expand a pico cell's service area significantly, since reliable control channel performance will require the signal-to-noise-plus-interference ratio (SINR) of the pico cell to be above a threshold over its service area.

To reduce interference, eICIC is used. However, in eICIC a determination of which subsets of macro cells must be silenced simultaneously and for how long must be made. The determination is based on a balance between mitigating interference to users served by pico cells and retaining adequate resources at the macro cells for their own UEs to be served.

The inventors have discovered centralized framework for addressing both load balancing and inter-cell interference coordination. The centralized framework combines convex relaxation with a Frank-Wolfe algorithm for convex optimization. The inventors have discovered that the Frank-Wolfe algorithm is applicable to load balancing and inter-cell interference coordination in HetNets.

At least one example embodiment discloses a method of balancing load and coordinating interference across a plurality of macro cells and small cells in a cellular network including the plurality of macro cells and small cells. The method includes determining serving cells of users, respectively, based on a Frank-Wolfe algorithm.

In an example embodiment, the method further includes determining subsets of the plurality of cells, the subsets determined such that the cells in a same subset transmit simultaneously and determining transmitting time fractions for the subsets of cells, respectively, based on the Frank-Wolfe algorithm, the transmitting time fractions indicating a fraction of time when the respective cells in the respective subset are all on.

In an example embodiment, the method further includes determining transmitting time fractions allocated by the serving cells to the respective users based on the Frank-Wolfe algorithm.

In an example embodiment, the determining the time fractions determines transmitting bit rates for the users, respectively.

In an example embodiment, the determining a transmitting time fraction includes determining frequency fractions allocated to the users based on the Frank-Wolfe algorithm.

In an example embodiment, the determining the serving cells, the determining transmitting time fractions for the subsets of cells and the determining the transmitting time fractions for the users maximize a system objective function of data rates for the users in the cellular network.

In an example embodiment, the maximization of a system objective function is

$${max}_{\{ {c}_{u} \} , \{ {y}^{( G )} \} , \{ {t}_{u , c}^{( G )} ( b ) \} , \{ {r}_{u} \}} {\sum }_{u ∈ U} log ( {r}_{u} )$$

wherein, cᵤ is the serving cell for the user, y^{(G)} is a fraction of time for which a cell subset G is active, t_{u,c}^{(G)}(b)≧0 is a fraction of time for which the cell subset G is active and cell c serves UE u in sub-band b, and rᵤ is a bit rate that the user achieves.

In an example embodiment,

$${c}_{u} ∈ {C}_{u} for all u ∈ U ; \\ {y}^{( G )} \geq 0 for all G ∈ Γ , {\sum }_{G ∈ Γ} {y}^{( G )} = 1 ; \\ \begin{matrix}{t}_{u , c}^{( G )} ( b ) \geq 0 for all u ∈ U \\ {\sum }_{u ∈ U} {t}_{u , c}^{( G )} ( b ) = {y}^{( G )}\end{matrix} \} for all G ∈ Γ , c ∈ C , \\ b ∈ \{ 1 , 2 , … , B \} ;$$

wherein Cᵤ is a set of candidate serving cells, U represents all users in the network and Γ as a collection of the cell subsets in the network.

In an example embodiment,

$${r}_{u} = {\sum }_{c ∈ {C}_{u}} {\sum }_{G ∈ Γ} {\sum }_{b = 1}^{B} {t}_{u , c}^{( G )} ( b ) {R}_{u , c}^{( G )} ( b ) for all u ∈ U$$

In an example embodiment, the method further includes permitting the users to be served by a plurality of candidate serving cells before determining the serving cells using convex relaxation.

In an example embodiment, the determining the serving cells determines the serving cells for the users by determining a cell having a highest contribution to a bit rate of the user in the convex relaxation.

At least one example embodiment discloses a controller configured to balance load and coordinate interference across a plurality of macro cells and small cells in a cellular network including the plurality of macro cells and small cells, the controller further configured to determine serving cells of users, respectively, based on a Frank-Wolfe algorithm.

In an example embodiment, the controller is configured to determine subsets of the plurality of cells, the subsets determined such that the cells in a same subset transmit simultaneously and determine transmitting time fractions for the subsets of cells, respectively, based on the Frank-Wolfe algorithm, the transmitting time fractions indicating a fraction of time when the respective cells in the respective subset are all on.

In an example embodiment, the controller is configured to determine transmitting time fractions allocated by the serving cells to the respective users based on the Frank-Wolfe algorithm.

In an example embodiment, the controller is configured to determine transmitting bit rates for the users, respectively.

In an example embodiment, the controller is configured to determine frequency fractions allocated to the users based on the Frank-Wolfe algorithm.

In an example embodiment, the controller is configured to maximize a system objective function of data rates for the users in the cellular network.

In an example embodiment, the maximization of a system objective function is

$${max}_{\{ {c}_{u} \} , \{ {y}^{( G )} \} , \{ {t}_{u , c}^{( G )} ( b ) \} , \{ {r}_{u} \}} {\sum }_{u ∈ U} log ( {r}_{u} )$$

wherein, cᵤ is the serving cell for the user, y^{(G)} is a fraction of time for which a cell subset G is active, t_{u,c}^{(G)}(b)≧0 is a fraction of time for which the cell subset G is active and cell c serves UE u in sub-band b, and rᵤ is a bit rate that the user achieves.

In an example embodiment,

cᵤ∈Cᵤ for all u∈U;

$${y}^{( G )} \geq 0 for all G ∈ Γ , {\sum }_{G ∈ Γ} {y}^{( G )} = 1 ; \\ \begin{matrix}{t}_{u , c}^{( G )} ( b ) \geq 0 for all u ∈ U \\ {\sum }_{u ∈ U} {t}_{u , c}^{( G )} ( b ) = {y}^{( G )} \end{matrix} \} for all G ∈ Γ , \\ c ∈ C , b ∈ \{ 1 , 2 , … , B \} ;$$

wherein Cᵤ is a set of candidate serving cells, U represents all users in the network and Γ as a collection of the cell subsets in the network.

In an example embodiment,

$${r}_{u} = {\sum }_{c ∈ {C}_{u}} {\sum }_{G ∈ Γ} {\sum }_{b = 1}^{B} {t}_{u , c}^{( G )} ( b ) {R}_{u , c}^{( G )} ( b ) for all u ∈ U$$

In an example embodiment, the controller is configured to permit the users to be served by a plurality of candidate serving cells before determining the serving cells using convex relaxation.

In an example embodiment, the controller is configured to determine the serving cells for the users by determining a cell having a highest contribution to a bit rate of the user in the convex relaxation.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 illustrates a communication architecture according to an example embodiment;

FIG. 2 illustrates a portion of a wireless communication system according to an embodiment;

FIG. 3 is a diagram illustrating an example structure of a wireless device;

FIG. 4 illustrates a method of balancing load and coordinating interference across a plurality of macro cells and small cells in a cellular network according to an example embodiment; and

FIG. 5 illustrates a method of performing a Frank-Wolfe algorithm according to an example embodiment.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As disclosed herein, the term “storage medium”, “storage unit” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “user equipment” or “UE” may be synonymous to a user equipment, mobile station, mobile user, access terminal, mobile terminal, user, subscriber, wireless terminal, terminal and/or remote station and may describe a remote user of wireless resources in a wireless communication network. Accordingly, a UE may be a wireless phone, wireless equipped laptop, wireless equipped appliance, etc.

The term “base station” may be understood as a one or more cell sites, base stations, nodeBs, enhanced NodeBs, access points, and/or any terminus of radio frequency communication. Although current network architectures may consider a distinction between mobile/user devices and access points/cell sites, the example embodiments described hereafter may also generally be applicable to architectures where that distinction is not so clear, such as ad hoc and/or mesh network architectures, for example.

Communication from the base station to the UE is typically called downlink or forward link communication. Communication from the UE to the base station is typically called uplink or reverse link communication.

Serving base station may refer to the base station currently handling communication needs of the UE.

Communication from the base station to the UE is typically called downlink or forward link communication. Communication from the UE to the base station is typically called uplink or reverse link communication.

FIG. 1 illustrates a system for load balancing and interference coordination, according to an example embodiment. The network shown in FIG. 1 may be a HetNet LTE network, but is not limited thereto. A network 100 includes a plurality of macro cells 105, 150. While only two macro cells are shown, the network of FIG. 1 may include more than two macro cells. Each macro cell includes a macro base station 110. The macro base station 110 is a serving base station to a UE 130. As shown, while the macro base station 110 is the serving base station, there exists a pass loss L_{e-c} between the UE and the cell-c. There also exists a path loss Lₑ between the macro base station 110 and the UE 130.

FIG. 2 illustrates a more detailed view portion of a macro cell in a HetNet according to an embodiment. As shown, the HetNet includes the macro cell 105 served by the macro base station 110. The macro cell and macro base station may both be referred to as a macro cell or a macro. The macro cell includes a number of small cells 115 served by respective small cell base stations 120. In one embodiment, the macro and small cells are Long Term Evolution (LTE) macro and small cells. However, the embodiments are not limited to this radio access technology (RAT), and the macro and small cells may be of different RATs. Furthermore, the macro base station 110 and the small cell base stations 120 communicate with each other over X2 interfaces as shown in FIG. 2. UEs 130 may be present in the macro and small cells.

Referring back to FIG. 1, the network 100 communicates with a network controller 205. Each base station 110 is configured to communicate topology and propagation data regarding the network 100 to the network controller 205 over a link 210. Moreover, the network controller 205 and the network 100 communicate traffic data and configuration parameters (e.g., P₀ and α) over link 215. Between each base station 110 and the network controller 205 is an Element Manager System (EMS) that is part of network management. The EMS (a) stores the measurements transmitted periodically by the network elements and (b) sends configuration instructions to the network elements. The network controller 205 obtains the measurements stored in the EMS via link 210 and the nature of this interface may be IP, Memory etc. The network controller 205 sends configuration parameters (e.g. P₀ and α) to the EMS via the link 215.

The EMS includes an operations, administration and maintenance (OAM) capabilities. The OAM capabilities allow the network controller to communicate with the LTE RAN 100 via a provisioning interface such as the link 210.

Using OAM capabilities, the EMS is responsible for the configuration, operations and maintenance of various RAN nodes. Various RAN and core network nodes communicate with the EMS through northbound interfaces (e.g., provisioning interface) that allow the EMS to download configuration data to the RAN and core network nodes and to obtain performance statistics from the RAN and core network nodes.

The network controller 205 communicates with the base stations of the LTE RAN as well as the other nodes of the core network (e.g., PRCF, which is not shown).

The network controller 205 is a network element or entity that enables application of radio frequency congestion control mechanisms (e.g., SON CCO algorithms and RAN Load Balancing) and core network congestion control mechanisms (e.g., policy-based functions) to be coordinated at a single network entity. Coordinating application of core network congestion control mechanisms and radio frequency congestion control mechanisms may improve congestion control and provide a more optimal response to network congestion. The operations and functionality of the network controller 205 will be described in more detail later.

In one example, the network controller 205 may be a conventional server or other computer device including one or more Central Processing Units (CPUs), digital signal processors (DSPs), application-specific-integrated-circuits, field programmable gate arrays (FPGAs) computers or the like configured to implement the functions and/or acts discussed herein. These terms in general may be referred to as processors.

The network controller 205 may be located in a centralized location in the communication system, for example, at a layer above OAM node (element management system). Since the network controller 205 coordinates actions across multiple nodes, these multiple nodes communicate with the network controller 205 through northbound interfaces that allow each node to send performance counters to a centralized location.

The network controller 205 includes a database for network data. The database saves traffic load, SINR distribution at different cells and path loss distributions, for example. It is important to note that the database does not require exact location traffic hot-spot and load. Moreover, the network controller may store data to perform to algorithms described with in FIG. 4.

FIG. 3 is a diagram illustrating an example structure of a wireless device. The wireless device may be a user equipment (UE), a base station or network controller. The wireless device may include, for example, a transmitting unit 310, a receiving unit 320, a memory unit 330, a processing unit 340, and a data bus 350.

The transmitting unit 310, receiving unit 320, memory unit 330, and processing unit 340 may send data to and/or receive data from one another using the data bus 350. The transmitting unit 310 is a device that includes hardware and any necessary software for transmitting wireless signals including, for example, data signals, control signals, and signal strength/quality information via one or more wireless connections to other wireless devices.

The receiving unit 320 is a device that includes hardware and any necessary software for receiving wireless signals including, for example, data signals, control signals, and signal strength/quality information via one or more wireless connections from other wireless devices,

The memory unit 330 may be any storage medium capable of storing data including magnetic storage, flash storage, etc.

The processing unit 340 may be any device capable of processing data including, for example, a microprocessor configured to carry out specific operations based on input data, or capable of executing instructions included in computer readable code. For example, the processing unit 340 is capable of implementing the methods described in detail below.

Conventionally, for ABS determination, all macros are active at the start of an ABS period, and then each macro shuts off at a certain time and remains off for the rest of the ABS period. This type of ABS determination is described in “Algorithms for enhanced inter-cell interference coordination (eICIC) in LTE HetNets,” Deb et al., the entire contents of which are hereby incorporated by reference. The conventional ABS determination creates at most M+1 different subsets of active macro cells during the ABS period, where M is the number of macros. Further, these subsets of cells are constrained to have a nested structure where all macros are initially active, then one drops out, then another until all macros are off. The order in which the macros shut off is also subject to optimization, so exactly which M+1 subsets is not fixed in advance.

In at least one example embodiment, a network controller obtains a multi-cell convex relaxation by allowing each UE to be served by multiple cells, then solves the relaxation optimally, and uses that solution to obtain a solution.

In terms of time-multiplexing a given collection of cell subsets, the corresponding convex relaxation may be determined by a Frank-Wolfe algorithm. Each iteration in the Frank-Wolfe algorithm may be terminated at a solution that is within a gap from an optimal solution (e.g., at least 99% of the optimal value).

The cell associations are fixed, i.e., each UE is assigned to the cell contributing the most to its rate in the solution to the multi-cell convex relaxation. The fixed associations are used (again using Frank-Wolfe) to obtain the ABS-related parameters.

FIG. 4 illustrates a method of balancing load and coordinating interference across a plurality of macro cells and small cells in a cellular network including the plurality of macro cells and small cells. The method may be performed by the network controller, 205, for example.

In a cellular network, the network includes a set M of macro cells, a set P of pico cells, and a set U of UEs to be served on the downlink by these cells. C represents the set of all cells in the network and Cᵤ is a set of candidate serving cells for a UE.

Communication from the cells to the UEs occurs over a channel divided into B frequency sub-bands, indexed 1, 2, . . . , B, for the purposes of UE scheduling.

Each UE is served by a single cell, and each cell serves a single user at a time in each sub-band.

The network controller selects each UE's candidate serving cells according to:

$${C}_{u} = \{ c ∈ C \text{:} {SNR}_{u , c} \geq \frac{1}{B} {max}_{{c}^{′} ∈ C} {SNR}_{u , {c}^{′}} \} , for some B \geq 1 \qquad ( 1 )$$

where SNR_{u,c} denotes the SNR of cell c at UE u, averaged over small-scale fading. In words, any cell whose SNR is at least 1/B of the maximum SNR over all cells is considered a candidate serving cell for a user. However, example embodiments are not limited thereto.

The network controller defines Γ as a collection of cell groups in the network where

Γ⊂2^{C} (2)

At S405, the network controller determines subsets of the plurality of cells. The subsets may be referred to as cell groups. Each cell group is a subset of cells allowed to be simultaneously active and transmitting. In other words, at any time, the cells that are active constitute one of the cell groups in Γ.

When Γ equals {C}, all cells are active all the time. There is no interference coordination through time-domain resource partitioning between macro and pico cells. When Γ equals {C,P}, on the other hand, either all cells are active (macro and pico) or all pico cells alone are active (i.e., all macro cells are silenced synchronously for certain periods of time).

In an example embodiment, the network controller sets

Γ={C}∪U_{p∈P}{C−Iₚ} (3)

where Iₚ is a set of strongly interfering macros for pico p, and U_{peP} is union over all pico cells. Iₚ may be determined based on empirical data. In words, at any time, either all cells are active, or all cells except the strongly interfering macros for some pico are active.

For example, the network controller defines Iₚ as the macro cells whose SNR at a UE that could be served by pico p is at least 1/α of the SNR at that user of pico p itself (for a suitable α≧0), where:

$${I}_{p} = \{ m ∈ M \text{:} ∃ u s . t . p ∈ {C}_{u} and {SNR}_{u , m} \geq ( \frac{1}{α} ) {SNR}_{u , p} \} \qquad ( 4 )$$

Note that setting α to be zero results in Γ being {C} and setting α to be infinity results in Γ being {C,P}. Intermediate values of α allow more refined choices for which macros to silence simultaneously, at the expense of greater computational complexity (due to the larger number of cell groups).

It should be noted, however, that example embodiments are not restricted to any particular way of choosing the cell groups.

When the number of cell groups is large, it is impractical for each UE to compute exactly the rate it would achieve when served by each of its candidate serving cells, for each choice of active cell group, and feed the rates back on the uplink.

To simply the computations, with the choice of cell groups described above, the network controller may set a rate in bits/sec for a UE u in a sub-band b to be:

R_{u,m}^{(G)}(b)=R_{u,m}^{(C)}(b) (5),

, for any macro cell m and any cell group G;

R_{u,p}^{(G)}(b)=R_{u,p}^{(C)}(b) (6),

for any pico cell p and any cell group G that contains p and intersects Iₚ; and

R_{u,p}^{(G)}(b)=R_{u,p}^{(C-I}^{ₚ}⁾(b) (7),

for any pico p∈P and any cell group G that contains p and does not intersect Iₚ (all other rates would be 0). Consequently, a UE u has to compute and feedback only one rate for each macro cell-sub-band pair (m,b) (viz., R_{u,m}^{(C)}(b)), and at most two different rates for each pico cell-sub-band pair (p,b) (viz., R_{u,p}^{(C)}(b) and R_{u,p}^{(C-I}^{ₚ}⁾(b)).

The bit rate R_{u,c}^{(G)}(b), is the rate that UE u would achieve as the only UE served by cell c∈C, with only the cells in cell group G∈Γ being active (the network controller sets R_{u,c}^{(G)}(b)=0 if c∉G∩Cᵤ).

To balance the load and reduce interference, the network controller maximizes an objective function of the form:

Σ_{u∈U}Fᵤ(rᵤ) (8)

where Fᵤ is a utility function for user u.

The following notations are used in the description of example embodiments:
1. cᵤ denotes the serving cell chosen for UE u.
2. y^{(G)}≧0 denotes a fraction of time for which cell group G is active. Since exactly one of the cell groups is active at a time,

$${\sum }_{G ∈ Γ} {y}^{( G )} = 1 \qquad ( 9 )$$

3. t_{u,c}^{(G)}(b)≧0 denotes a fraction of time for which cell group G is active and cell c serves UE u in sub-band b. Since each cell serves exactly one user at a time in each sub-band,

$$\begin{matrix}{\sum }_{u ∈ U} {t}_{u , c}^{( G )} ( b ) = {y}^{( G )} & ( 10 ) \\ {r}_{u} = {\sum }_{G ∈ Γ} {\sum }_{b = 1}^{B} {t}_{u , {c}_{u}}^{( G )} ( b ) {R}_{u , {c}_{u}}^{( G )} ( b ) & ( 11 )\end{matrix}$$

denotes the overall rate in bits/sec that the UE u achieves.

In an example embodiment,

Fᵤ(r)=log(r) (12)

for all users (which corresponds to requiring proportional fairness in the user rates). It should be understood example embodiments are not limited thereto.

The maximization variables are the serving cell assignments {cᵤ}, the cell group time fractions {y^{(G)}}, the user time fractions {t_{u,c}^{(G)}(b)}, and the user rates {rᵤ}. The maximization of the objective function becomes:

$${max}_{\{ {c}_{u} \} , \{ {y}^{( G )} \} , \{ {t}_{u , c}^{( G )} ( b ) \} , \{ {r}_{u} \}} {\sum }_{u ∈ U} log ( {r}_{u} ) \qquad ( 13 )$$

subject to

$$\begin{matrix}{c}_{u} ∈ {C}_{u} for all u ∈ U ; & ( 14 ) \\ {y}^{( G )} \geq 0 for all G ∈ Γ , {\sum }_{G ∈ Γ} {y}^{( G )} = 1 ; & ( 15 ) \\ \begin{matrix}{t}_{u , c}^{( G )} ( b ) \geq 0 for all u ∈ U \\ {\sum }_{u ∈ U} {t}_{u , c}^{( G )} ( b ) = {y}^{( G )}\end{matrix} \} for all G ∈ Γ , c ∈ C , \\ b ∈ \{ 1 , 2 , … , B \} ; & ( 16 ) \\ {r}_{u} = {\sum }_{G ∈ Γ} {\sum }_{b = 1}^{B} {t}_{u , {c}_{u}}^{( G )} ( b ) {R}_{u , {c}_{u}}^{( G )} ( b ) for all u ∈ U . & ( 17 )\end{matrix}$$

The network controller convexly relaxes the constraint that each US must be served by a single cell (chosen from its set of candidate serving cells) and allows each UE to be served simultaneously by one or more of its candidate serving cells. The convex relaxation leads to a tractable convex program:

$${max}_{\{ {y}^{( G )} \} , \{ {t}_{u , c}^{( G )} ( b ) \} , \{ {r}_{u} \}} {\sum }_{u ∈ U} log ( {r}_{u} ) , \qquad ( 18 )$$

which is subject to (15) and (16), and

$${r}_{u} = {\sum }_{c ∈ {C}_{u}} {\sum }_{G ∈ Γ} {\sum }_{b = 1}^{B} {t}_{u , c}^{( G )} ( b ) {R}_{u , c}^{( G )} ( b ) for all u ∈ U \qquad ( 19 )$$

Referring back to FIG. 4, the network controller determines serving cells for the users, respectively, based on the Frank-Wolfe algorithm at S410.

The network controller solves the convex relaxation described in equations (18) and (19). The solutions of the convex relaxation are denoted as ({\tilde{y}^{(G)}},{\tilde{t}_{u,c}^{(G)}(b)},{\tilde{r}ᵤ}).

FIG. 5 illustrates an example embodiment of the Frank-Wolfe algorithm utilized by the network controller. At S505, the network controller initializes ({\tilde{y}^{(G)}},{\tilde{t}_{u,c}^{(G)}(b)},{\tilde{r}ᵤ}) to an arbitrary feasible solution. For example, the network controller may initialize ({\tilde{y}^{(G)}},{\tilde{t}_{u,c}^{(G)}(b)},{\tilde{r}ᵤ}) as:

\tilde{y}^{(G)}=|Γ|⁻¹

for each group G (all cell groups are given equal time);

\tilde{t}_{u,c}^{(G)}(b)=|U_{c}|⁻,

where U_{c} is a subset of users for which cell c is a candidate serving cell (whichever cell group G is active, each cell gives equal time to all the UEs it can serve, in each sub-band); and

$${\tilde{r}}_{u} = {\sum }_{c ∈ {C}_{u}} {\vert {U}_{c} \vert}^{- 1} {\sum }_{G ∈ Γ} {\sum }_{b = 1}^{B} {R}_{u , c}^{( G )} ( b )$$

for each UE.

At S510, the network controller then determines a solution ({ŷ^{(G)}},{\hat{t}_{u,c}^{(G)}(b)},{\hat{r}ᵤ}) that maximizes the first-order approximation Σ_{u∈U}[log(\tilde{r}ᵤ)+\tilde{r}ᵤ⁻¹(rᵤ−\tilde{r}ᵤ)] of the objective function at the current candidate solution ({\tilde{y}^{(G)}},{\tilde{t}_{u,c}^{(G)}(b)},{\tilde{r}ᵤ}). This is a linear program that can be solved by inspection. The solution corresponds to a single cell group Ĝ∈Γ being active all the time, and each cell c∈C serving a single user û_{c}(b)∈U_{c} all the time in each sub-band b. The networks makes the following determinations:

$$\begin{matrix}\hat{G} = {argmax}_{G ∈ Γ} {\sum }_{c ∈ G} {\sum }_{b = 1}^{B} {max}_{u ∈ {U}_{c}} [ \frac{{R}_{u , c}^{( G )} ( b )}{{\tilde{r}}_{u}} ] , & ( 20 ) \\ {\hat{u}}_{c} ( b ) = {argmax}_{u ∈ {U}_{c}} \frac{{R}_{u , c}^{( \hat{G} )} ( b )}{{\tilde{r}}_{u}} , & ( 21 )\end{matrix}$$

with all ties resolved arbitrarily. Thus, for each cell group G,

$${\hat{y}}^{( G )} = \{ \begin{matrix}1 & if G = \hat{G} , \\ 0 & otherwise ,\end{matrix} \qquad ( 22 )$$

and, for each cell c, user u, and sub-band b,

$${\hat{t}}_{u , c}^{( G )} ( b ) = \{ \begin{matrix}1 & if G = \hat{G} and u = {\hat{u}}_{c} ( b ) , \\ 0 & otherwise .\end{matrix} \qquad ( 23 )$$

The resulting rate in bits/sec for UE u is

$${\hat{r}}_{u} = {\sum }_{c ∈ {C}_{u}} {\sum }_{b = 1}^{B} {\hat{t}}_{u , c}^{( \hat{G} )} ( b ) {R}_{u , c}^{( \hat{G} )} ( b ) \qquad ( 24 )$$

At S515, the network controller analyzes a geometric mean M of UE rates. The geometric mean of the UE rates at a final solution lies between

\tilde{M}=exp{|U|⁻¹(\tilde{r}ᵤ)}

(the geometric mean of the user rates at the current candidate solution), and

\hat{M}=exp{|U|⁻¹Σ_{u∈U}[log(\tilde{r}ᵤ)+_{\tilde{r}}ᵤ⁻¹(\hat{r}ᵤ−\tilde{r}ᵤ]}

(by the concavity of the objective function).

The ratio \hat{M}/\tilde{M} of these bounds approaches 1 for each additional iteration. Accordingly, the network controller terminates the algorithm if

\tilde{M}>(1−∈)/\hat{M}

If the geometric mean of the UE rates at the final solution is at least a fraction 1−∈ (e.g., ∈=10⁻³) of that at an optimal solution, the Frank-Wolfe algorithm in FIG. 5 ends.

Otherwise, i.e., if \tilde{M}≧(1−∈)\hat{M}, the network controller performs an Armijo line search at S520. The network controller identifies a point on the line joining the current candidate solution ({\tilde{y}^{(G)}},{\tilde{t}_{u,c}^{(G)}(b)},{\tilde{r}ᵤ}) and the linear-program solution ({ŷ^{(G)}},{\hat{t}_{u,c}^{(G)}(b)},{\hat{r}ᵤ}), and updates the current candidate solution as:

\tilde{y}^{(G)}←(1−α*)\tilde{y}^{(G)}+α*ŷ^{(G)},

\tilde{t}_{u,c}^{(G)}(b)←(1−α*)\tilde{t}_{u,c}^{(G)}(b)+α*\tilde{t}_{u,c}^{(G)}(b),

\tilde{r}ᵤ←(1−α*)\tilde{r}ᵤ+α*\hat{r}ᵤ.

where, α*∈(0,1). In an example embodiment, α* is determined by the Armijo rule where

α*=β^{k*},

where β∈(0,1) is a chosen constant (e.g., β=0.5), and k* is the smallest nonnegative integer k such that

$${\sum }_{u ∈ U} log [ ( 1 - {β}^{k} ) {\tilde{r}}_{u} + {β}^{k} {\hat{r}}_{u} ] \geq {\sum }_{u ∈ U} [ log ( {r}_{u} ) + σ {β}^{k} ( \frac{{\hat{r}}_{u} - {\tilde{r}}_{u}}{{\tilde{r}}_{u}} ) ] ,$$

with σ∈(0,1) also being a chosen constant (e.g., σ=10⁻²). The network controller then proceeds to S510.

After performing the Frank-Wolfe algorithm, for each UE u, the network controller determines a candidate serving cell c̅ᵤ̅ that contributes most to the UE's rate in the solution to the convex relaxation. More specifically, the network controller determines the candidate serving cell c̅ᵤ̅ as:

$${\overline{c}}_{u} = {argmax}_{c ∈ {C}_{u}} {\sum }_{G ∈ Γ} {\sum }_{b = 1}^{B} {\tilde{t}}_{u , c}^{( G )} ( b ) {R}_{u , c}^{( G )} ( b ) \qquad ( 25 )$$

Referring back to FIG. 4, the network controller then determines transmitting time fractions for the subsets of cells and time fractions allocated by the serving cells to the respective users based on the Frank-Wolfe algorithm at S415. More specifically, the network controller solves the convex relaxation described in equations (18) and (19) again, but now with the set of candidate serving cells for each UE set to Cᵤ={ c̅ᵤ} (single candidate serving cell for each user). A final solution of S415 is denoted by ({ŷ^{(G)}},{\hat{t}_{u,c}^{(G)}(b)},{\hat{r}ᵤ}). This second iteration of the Frank-Wolfe algorithm is the same as the algorithm described in FIG. 5. Therefore, for the sake of brevity, the second second iteration will not be further described.

The final solution is then ({ c̅ᵤ̅},{ŷ^{(G)}},{\hat{t}_{u,c}^{(G)}(b)},{\hat{r}ᵤ}).

As described, the network controller solves two instances of the convex relaxation in equations (18) and (19). The first instance yields an upper bound on the optimal value of equation (13), which is useful in assessing the optimality gap of the final solution ({ c̅ᵤ̅},{ŷ^{(G)}},{\hat{t}_{u,c}^{(G)}(b)},{\hat{r}ᵤ}). The second instance of equations (18) and (19) has a trivial load balancing component (single candidate serving cell for each user).

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method of balancing load and coordinating interference across a plurality of macro cells and small cells in a cellular network including the plurality of macro cells and small cells, the method comprising:
determining serving cells of users, respectively, based on a Frank-Wolfe algorithm.

2. The method of claim 1, further comprising:
determining subsets of the plurality of cells, the subsets determined such that the cells in a same subset transmit simultaneously; and
determining transmitting time fractions for the subsets of cells, respectively, based on the Frank-Wolfe algorithm, the transmitting time fractions indicating a fraction of time when the respective cells in the respective subset are all on.

3. The method of claim 2, further comprising:
determining transmitting time fractions allocated by the serving cells to the respective users based on the Frank-Wolfe algorithm.

4. The method of claim 3, wherein the determining the time fractions determines transmitting bit rates for the users, respectively.

5. The method of claim 3, wherein the determining a transmitting time fraction includes,
determining frequency fractions allocated to the users based on the Frank-Wolfe algorithm.

6. The method of claim 5, wherein the determining the serving cells, the determining transmitting time fractions for the subsets of cells and the determining the transmitting time fractions for the users maximize a system objective function of data rates for the users in the cellular network.

7. The method of claim 6, wherein the maximization of a system objective function is
$${max}_{\{ {c}_{u} \} , \{ {y}^{( G )} \} , \{ {t}_{u , c}^{( G )} ( b ) \} , \{ {r}_{u} \}} {\sum }_{u ∈ U} log ( {r}_{u} )$$
wherein, cᵤ is the serving cell for the user, y^{(G)} is a fraction of time for which a cell subset G is active, t_{u,c}^{(G)}(b)≧0 is a fraction of time for which the cell subset G is active and cell c serves UE u in sub-band b, and rᵤ is a bit rate that the user achieves.

8. The method of claim 7, wherein
$${c}_{u} ∈ {C}_{u} for all u ∈ U ; \\ {y}^{( G )} \geq 0 for all G ∈ Γ , {\sum }_{G ∈ Γ} {y}^{( G )} = 1 ; \\ \begin{matrix}{t}_{u , c}^{( G )} ( b ) \geq 0 for all u ∈ U \\ {\sum }_{u ∈ U} {t}_{u , c}^{( G )} ( b ) = {y}^{( G )}\end{matrix} \} for all G ∈ Γ , \\ c ∈ C , b ∈ \{ 1 , 2 , … , B \} ;$$
wherein Cᵤ is a set of candidate serving cells, U represents all users in the network and Γ as a collection of the cell subsets in the network.

9. The method of claim 8, wherein
$${r}_{u} = {\sum }_{c ∈ {C}_{u}} {\sum }_{G ∈ Γ} {\sum }_{b = 1}^{B} {t}_{u , c}^{( G )} ( b ) {R}_{u , c}^{( G )} ( b ) for all u ∈ U$$

10. The method of claim 1, further comprising:
permitting the users to be served by a plurality of candidate serving cells before determining the serving cells using convex relaxation.

11. The method of claim 10, wherein the determining the serving cells determines the serving cells for the users by determining a cell having a highest contribution to a bit rate of the user in the convex relaxation.

12. A controller configured to balance load and coordinate interference across a plurality of macro cells and small cells in a cellular network including the plurality of macro cells and small cells, the controller further configured to,
determine serving cells of users, respectively, based on a Frank-Wolfe algorithm.

13. The controller of claim 12, wherein the controller is configured to
determine subsets of the plurality of cells, the subsets determined such that the cells in a same subset transmit simultaneously; and
determine transmitting time fractions for the subsets of cells, respectively, based on the Frank-Wolfe algorithm, the transmitting time fractions indicating a fraction of time when the respective cells in the respective subset are all on.

14. The controller of claim 13, wherein the controller is configured to
determine transmitting time fractions allocated by the serving cells to the respective users based on the Frank-Wolfe algorithm.

15. The controller of claim 14, wherein the controller is configured to determine transmitting bit rates for the users, respectively.

16. The controller of claim 14, wherein the controller is configured to determine frequency fractions allocated to the users based on the Frank-Wolfe algorithm.

17. The controller of claim 16, wherein the controller is configured to maximize a system objective function of data rates for the users in the cellular network.

18. The controller of claim 17, wherein the maximization of a system objective function is
$${max}_{\{ {c}_{u} \} , \{ {y}^{( G )} \} , \{ {t}_{u , c}^{( G )} ( b ) \} , \{ {r}_{u} \}} {\sum }_{u ∈ U} log ( {r}_{u} )$$
wherein, cᵤ is the serving cell for the user, y^{(G)} is a fraction of time for which a cell subset G is active, t_{u,c}^{(G)}(b)≧0 is a fraction of time for which the cell subset G is active and cell c serves UE u in sub-band b, and rᵤ is a bit rate that the user achieves.

19. The controller of claim 18, wherein
$${c}_{u} ∈ {C}_{u} for all u ∈ U ; \\ {y}^{( G )} \geq for all G ∈ Γ , {\sum }_{G ∈ Γ} {y}^{( G )} = 1 ; \\ \begin{matrix}{t}_{u , c}^{( G )} ( b ) \geq 0 for all u ∈ U \\ {\sum }_{u ∈ U} {t}_{u , c}^{( G )} ( b ) = {y}^{( G )} \end{matrix} \} for all G ∈ Γ , c ∈ C , \\ b ∈ \{ 1 , 2 , … , B \} ;$$
wherein Cᵤ is a set of candidate serving cells, U represents all users in the network and Γ as a collection of the cell subsets in the network.

20. The controller of claim 19, wherein
$${r}_{u} = {\sum }_{c ∈ {C}_{u}} {\sum }_{G ∈} {\sum }_{b = 1}^{B} {t}_{u , c}^{( G )} ( b ) {R}_{u , c}^{( G )} ( b ) for all u ∈ U$$

21. The controller of claim 12, wherein the controller is configured to permit the users to be served by a plurality of candidate serving cells before determining the serving cells using convex relaxation.

22. The controller of claim 21, wherein the controller is configured to determine the serving cells for the users by determining a cell having a highest contribution to a bit rate of the user in the convex relaxation.
